(19) United States
(12) Patent Application Publication
(10) Pub. No.: US 2024/0065132 A1
(43) Pub. Date: Feb. 29, 2024

(54) AGRICULTURAL WORK SYSTEM AND METHOD FOR OPERATING AN AGRICULTURAL WORK SYSTEM

(71) Applicant: CLAAS Tractor SAS, VeIizy-Villacoublay Cedex (FR)

(72) Inventors: Christian Birkmann, Versmold (DE); Christian Schaub, Paderborn (DE)

(73) Assignee: CLAAS Tractor SAS, VeIizy-Villacoublay Cedex (FR)

(21) Appl. No.: 18/237,731

(22) Filed: Aug. 24, 2023

(30) Foreign Application Priority Data
Aug. 25, 2022 (DE) 10 2022 121 568.7

(51) Int. Cl. A01B 71/00; A01B 79/00

(52) U.S. Cl. CPC A01B 71/00; A01B 79/005

(57) ABSTRACT

An agricultural work system and a method for operating an agricultural work system are disclosed. The agricultural work system performs an agricultural work process and includes an agricultural production machine having at least two axles with at least one device interface and an attachment, which is connected via the device interface to the agricultural production machine. An axle load on at least one axle is determined using a sensor assembly, with the axle loads occurring or happening on axles of the agricultural production machine. An axle load ratio based thereon is cyclically determined using the computer unit of the driver assistance system of the agricultural production machine, coupled in time to the execution of the work process, with the driver assistance system taking into account the agricultural production machine and attachment configuration and operating parameters.

### CROSS REFERENCE TO RELATED APPLICATION

This application claims priority under 35 U.S.C. § 119 to German Patent Application No. DE 10 2022 121 568.7 filed Aug. 25, 2022, the entire disclosure of which is hereby incorporated by reference herein. This application is related to U.S. application Ser. No. ______ (attorney docket number 15191-23020A (P05619/8), incorporated by reference herein in its entirety.

### TECHNICAL FIELD

The present invention relates to a method for operating an agricultural work system and an agricultural work system.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

An agricultural work system may be formed by an agricultural production machine and an attachment connected to a device interface of the agricultural production machine. The agricultural work system may be configured to perform an agricultural work process, such as configured to optimize the ballasting in performing the agricultural work process. In configuring the agricultural work system, it may be necessary to determine axle loads bearing on axles of the agricultural production machine in the work process, which may be influenced by forces of the attachment which may be transmitted to the agricultural production machine via the device interface. The axle loads and the axle load distribution may significantly affect the overall efficiency in the execution of an agricultural work process and affect the wear and operational safety of the agricultural production machine. Accordingly before starting to execute the agricultural work process, the axle loads of the agricultural work system may be determined in order to set an axle load distribution required for the operation of the agricultural work system by suitable ballasting. The performed ballasting may be based on the axle load distribution determined before the start of the execution of the agricultural work process.

DE 10 2015 114 262 A1, incorporated by reference herein in its entirety, discloses a device and a method for determining the axle load on the axles of the agricultural production machine.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 schematically illustrates a side view of an agricultural production machine of an agricultural work system;

FIG. 2 schematically illustrates the agricultural work system consisting of the agricultural production machine and mounted attachment; and

FIG. 3 schematically illustrates a representation of only the agricultural production machine in an operating situation in which an attachment is attached to the device interface.

### DETAILED DESCRIPTION

As discussed in the background, the axle load on the axles of the agricultural production machine may initially be determined prior to beginning execution of the agricultural work process. While performing the agricultural work process, the axle load distribution may be subject to various influences depending on the configuration of the agricultural work system and operating parameters. In one or some embodiments, the operating parameters may be subject to changes, such as continuous changes, while performing or executing the agricultural work process, which may affect, such as directly affect, the axle load distribution and/or the axle load ratio(s). Inappropriately setting the axle load ratio may lead to increased fuel consumption, which may result in lower output per area, higher area-specific costs and/or increased wear on the agricultural production machine and/or the attachment.

As such, in one or some embodiments, a method for operating an agricultural work system and an agricultural work system is disclosed to enable more efficient operation of the agricultural work system taking into account or considering dynamically changing conditions during the execution of an agricultural work process.

Thus, in one or some embodiments, a method for operating an agricultural work system is disclosed, wherein the agricultural work system comprises an agricultural production machine having at least two axles with at least one device interface, and an attachment. The attachment is connected using the device interface to the agricultural production machine for performing an agricultural work process. An axle load on at least one axle may be determined using a sensor assembly. In one or some embodiments, axle loads arising or acting on the axles of the agricultural production machine, such as vertical axle loads, and an axle load ratio based thereon are determined, such as cyclically or periodically determined, by a computing unit of a driver assistance system of the agricultural production machine coupled in time to the execution of the work process, which may thus take into account the agricultural production machine and implemented configuration (with the attachment) and/or operating parameters for operating one or both of the agricultural production machine or the attachment.

In one or some embodiments, the driver assistance system may automatically consider the axle load distribution, which may be subject to significant changes during ongoing operation of the agricultural work system (e.g., during the execution of an agricultural work process), such as due to changing operating parameters. The extent to which and the manner in which the axle load distribution changes may be unknown to the operator of the agricultural work system and may not typically be directly perceptible. The determination, such as the cyclical determination, of the axle loads arising or acting on the axles of the agricultural production machine and the axle load ratio based thereon, which may be performed at specific, such as constant or predetermined, time intervals, may take into account one or both of the agricultural production machine and attachment and/or the current operating parameters, thereby making it possible to provide the operator with almost real-time information about the dynamically changing axle loads and the axle load distribution during the execution of the work process. In turn, this may make it possible (by taking suitable or appropriate measures, such as using automatically control) to improve or optimize parameters that affected or influenced by the axle load ratio, such as any one, any combination, or all of: fuel consumption; output per area; area-specific costs; soil compaction; or the wear on the agricultural production machine and the associated attachment.

In one or some embodiments, to determine the axle load, such as the vertical axle load, on at least one axle of the agricultural production machine, such as the front axle, provision may be made to determine this, for example, by using at least one sensed aspect, such as by using the pressure in the hydropneumatic or pneumatic suspension system or by using the displacement measurement in a mechanical suspension system. Alternatively, or in addition, a force-displacement measurement sensor system on the axle may be used to measure the at least one sensed aspect.

In one or some embodiments, the driver assistance system may include an operating and display unit through which any one, any combination, or all of the arising axle loads, the axle load ratio, or their changes during the performance of the work process may be visualized. Using the display, the operator may be made aware early on of changes that may have a detrimental effect on the parameters, such as by displaying on the display graphically displayed curves of any one, any combination, or all of the axle loads (e.g., vertical axle loads) and the axle load ratio.

In particular, the existing production machine and attachment configuration may be at least partially specified by an operator of the agricultural work system and/or at least partially determined automatically by the driver assistance system. Therefore, the determination of the dynamically changing axle loads may be based on an initial ballasting of the agricultural work system which may represent the initial values necessary for the subsequent determination during the work process. In so doing, the agricultural production machine configuration and the attachment configuration may be at least partially selected by the operator of the agricultural work system from a database stored in a memory unit of the driver assistance system. Alternatively or additionally, the driver assistance system may determine at least part of the agricultural production machine configuration and/or the attachment configuration in an interactive dialog with the operator. Alternatively or additionally, the driver assistance system may be configured to determine the attachment configuration. For this purpose, the driver assistance system may be configured to communicate with an attachment control system, for example, or to read out a data memory on the attachment. In this way, the driver assistance system may determine the attachment configuration.

The agricultural production machine configuration may comprise any one, any combination, or all of: the mass of the agricultural production machine; the position of the center of gravity of the empty agricultural production machine; the mass and position of additional weights arranged on the agricultural production machine; or the type of device interface on the agricultural production machine for connection to the attachment. For the weight forces resulting from the mass of the agricultural production machine and the weights attached to it, the influence of the terrain topology, inclines and declines, may be taken into account.

The attachment configuration may comprise any one, any combination, or all of: the mass of the attachment; the position of the center of gravity of the attachment; the point of application of the ground resistance forces/rolling resistances within the attachment; or the position of at least one weight-supporting device optionally arranged on the attachment. In addition, the mass of the attachment may also be influenced by storage tanks arranged thereon with varying fill levels, which may also be a subject of the attachment configuration. For example, an estimation of the soil resistance forces on tools for soil cultivation of an attachment may be made using tractive power and vehicle speed. In turn, tractive power may be determined using any one, any combination, or all of drive engine power, transmission efficiency, drive train efficiency, and/or an efficiency of the soil engaging means. Alternatively, the tractive power may be estimated using any one, any combination, or all of: transmission output power; drive train efficiency; or an efficiency of the soil engagement means. Other operating parameter combinations for estimating the tractive power are contemplated.

In one or some embodiments, the equipment interface may generally comprise a mechanical coupling between the agricultural production machine and the attachment. For this purpose, the device interface may be designed as a three-point power lifter. The device interface may be designed as a front or rear power lifter. Alternatively, the device interface may be a drawbar. Other variants of the device interface comprise systems with simple drawbar couplings, hitch hooks, ball head couplings, or the like.

In particular, given knowledge of the attachment configuration, a device interface load transmitted to the agricultural production machine via the at least one device interface may be determined on an attachment-specific basis. The device interface load may include one or both of weight-related load components (which may be gravity-related and/or inertia-related load components) and/or process-related load components (which may be due, for example, to the engagement between the attachment and the field soil that takes place during plowing or the like).

Furthermore, the driver assistance system may differentiate between attached and a mounted attachment for soil cultivation and a trailed attachment that serves to transport harvested material, auxiliary materials and/or operating materials.

Therefore, with a trailed attachment for soil cultivation, the driver assistance system, in a first step, may determine a vertical force supported on at least one weight-supporting device from a moment equilibrium about one of the axles, such as the rear axle, of the agricultural production machine, and may determine, in a second step, a vertical axle load acting on this axle. If the driver assistance system determines an axle load using the sensor assembly on the rear axle (e.g., using sensor data that is generated by the sensor assembly indicative of at least one aspect of the rear axle and that is accessed by the driver assistance system), the driver assistance system may determine the vertical force supported on the at least one weight-supporting device from a moment equilibrium around the front axle.

With a trailed attachment for soil cultivation, the driver assistance system, in a first step, may determine any one, any combination, or all of tool forces exerted on tools of the attachment via tractive power and current travel speed of the agricultural production machine, a coupling moment acting by the attachment on the agricultural production machine and/or a vertical coupling force via attachment geometry, and a moment equilibrium around the at least one weight-supporting device, and the driver assistance system, in a second step, may determine a vertical axle load acting on one of the axles, such as the rear axle.

With a trailed attachment which serves to transport harvested material, the driver assistance system may determine (e.g., estimate), in a first step, the rolling resistance of auxiliary materials and/or operating materials in order to determine the coupling forces, and the driver assistance system may determine, in a second step, a vertical axle load acting on one of the axles, in particular the rear axle. By way of example, the attachment used for transporting harvested material, auxiliary and/or operating materials may comprise a slurry tanker, a transport trailer and the like.

In one or some embodiments, the driver assistance system may take into account any one or both of a variable filling volume of a container resident on the attachment and/or the agricultural production machine and/or the spatial arrangement of the container in relation to the agricultural production machine when determining the axle load. Containers with variable filling volume may, in addition to a fuel tank, comprise an additive tank, a seed and/or fertilizer container, a liquid container of a crop protection sprayer, the slurry tank, and the like. The position or spatial arrangement and/or information on the maximum filling volume of a container may result from the attachment configuration and/or the work machine configuration. An actual fill level, which may change continuously during the execution of an agricultural work process, may be detected by sensors and evaluated by the computer unit of the driver assistance system or a separate evaluation unit.

Furthermore, in a third step, the driver assistance system may determine the axle load ratio and, in a fourth step, may estimate a drive torque at the axles of the agricultural production machine. In one or some embodiments, the execution of the third and fourth steps may be independent of whether the attachment is attached or mounted.

Thereby, for the estimation of the driving torque, the driver assistance system may estimate a driving force coefficient using quantities determined in the first and second steps for attached or mounted attachments. When estimating the driving torque, the respective design of soil engagement means of the agricultural production machine may have an influence. If instead of wheels, caterpillar tracks are used on at least one axle, a separate consideration of the mechanical properties and/or the design of the caterpillar tracks is provided. In this regard, various soil engagement means are contemplated, including wheels, tracks, or the like. The driver assistance system may estimate the driving force coefficient using an estimation of a tractive force, which may be determined from the tractive power and/or the current driving speed of the agricultural production machine.

In particular, the driver assistance system may specify a dialog-based procedure in order to determine the initial ballasting of the agricultural production machine. The dialog-based procedure, which may be interactive, may simplify the driver assistance system's determination of the initial ballasting. In this regard, the initial ballasting of one or both of the agricultural production machine or the attachment may be determined using a dialog-based sequence specified by the driver assistance system. By determining the initial ballasting, the driver assistance system may take into account influences on the procedural determination of the current axle load. In particular, no specific background knowledge need be required on the part of the operator in order for the driver assistance system to determine the initial ballasting if the operator is guided through the necessary substeps for determining the initial ballasting using a predefined step-by-step sequence of actions.

For the initial ballasting, any one, any combination, or all of the following may be determined: the unladen weight and center of gravity of the agricultural production machine; a calibration of an axle load measurement of the at least one axle to be measured (e.g., the front axle); a determination of a coupling moment for trailed attachments (e.g., with a torque-transmitting traction booster); or a center of gravity of mounted attachments.

In one or some embodiments, the driver assistance system may automatically compare the vertical axle loads determined cyclically during the execution of the work process and the axle load distribution with limit values and, if one of the limit values is exceeded, automatically issue a warning via the operating and display unit (e.g., a touchscreen display) to the operator. The warning may be used, for example, to indicate that the technical or legal axle loads have been exceeded or not reached.

In one or some embodiments, the driver assistance system may automatically perform one or more actions responsive to one or more of the limit values being exceeded. For example, the driver assistance system may be configured to perform one or both of: (1) automatically generate an output on the operating and display unit indicative of a recommendation for the operator to manually execute in order to modify or to adjust at least one operating parameter; and/or (2) automatically implement the recommended modified at least one operating parameter in order to automatically control one or both of the agricultural production machine and/or the attachment. In this regard, responsive to automatically determining an adjustment of at least one operating parameter when one of the limit values is exceeded, the driver assistance system may automatically suggest to the operator (via the operating and display unit) the recommended at least one operating parameter (in order for the operator to manually select the operating parameter) and/or may automatically implement the recommended at least one operating parameter. Various operating parameters to recommend modifying (and in turn outputting on the display and/or automatically change) are contemplated. For example, adaptable operating parameters of the agricultural work system may, for example, be a change in the front- or rear-mounted ballasting or an automatic adaptation of the tire pressure using a tire control system, using a compressor, or the like. Further adjustable operating parameters may comprise any one, any combination, or all of: a control of pneumatic or hydro-pneumatic spring units of the agricultural production machine; a chassis stiffness of the agricultural production machine; or a tractive force. Furthermore, an adjustment of one or more adjustment parameters of the attachment may be proposed. Alternatively, or in addition, the cyclic determination of vertical axle loads and axle load ratio may be used to calibrate transmission and brake parameters.

In one or some embodiments, an agricultural work system is disclosed. The agricultural work system may comprise an agricultural production machine having at least two axles with at least one device interface and an attachment which is connected using the device interface to the agricultural production machine for performing an agricultural work process. At least one sensor assembly may be configured to determine an axle load that is bearing on at least one axle. The agricultural production machine may further comprise a driver assistance system with a computing unit, which may be configured to automatically determine axle loads arising or bearing on the axles of the agricultural production machine and/or an axle load ratio based thereon, taking into account any one, any combination, or all of the agricultural production machine, the attachment configuration, or operating parameters, and may be linked in time to the execution of the work process.

In one or some embodiments, the agricultural work system may be configured to perform any of the actions described herein. Further, any one, some or all of the actions described herein may be performed automatically by at least a part of the agricultural work system, such as driver assistance system.

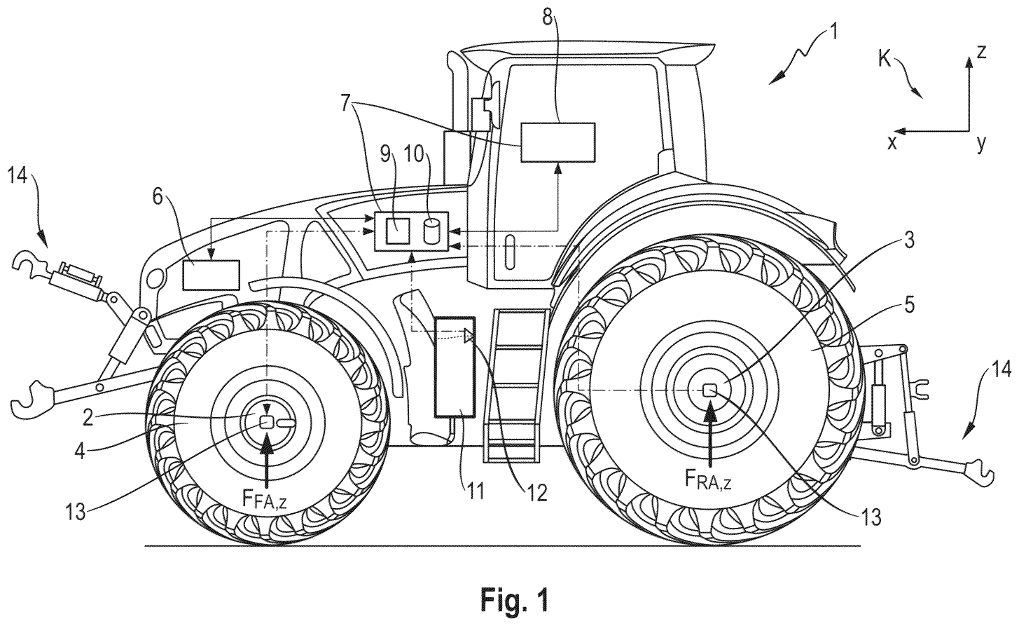

Referring to the figures, FIG. 1 shows a schematic side view of an agricultural production machine 1 of an agricultural work system. The agricultural production machine 1 designed as a tractor comprises soil engagement means 4, 5 arranged or positioned on axles 2, 3, which may be designed as running wheels, as shown in FIG. 1. Alternatively, or in addition, soil engagement means 4, 5 may comprise tracks. Axle 2 is hereinafter referred to as the front axle and axle 3 as the rear axle. The agricultural production machine 1 may be equipped with a drive unit 6, indicated schematically, which may include an internal combustion engine. In one or some embodiments, the drive unit 6 acts on the soil engagement means 4, 5 in the typical way via a drivetrain. In one or some embodiments, the agricultural production machine 1 is an all-wheel drive agricultural production machine 1 so that all four soil engagement means 4, 5 are driven or drivable. An example of agricultural production machine 1 is a tractor, an example of which is disclosed in US Patent Application Publication No. 2022/0000006 A1, incorporated by reference herein in its entirety.

The agricultural production machine 1 may include a driver assistance system 7, to which an operating and display unit 8 may be assigned, that is configured to provide an information interface to the operator of the agricultural production machine 1. In one or some embodiments, the operating and display unit 8 comprises a touchscreen. The driver assistance system 7 has a memory unit 10 for saving data and/or software (e.g., software to perform the steps for the driver assistance system 7 discussed herein), and a computing unit 9 for processing the data stored in the memory unit 10.

Thus, in one or some embodiments, computing unit 9 may include at least one processor and optionally at least one memory (separate from memory unit 10) that stores information (e.g., data) and/or software, with the processor configured to execute the software stored in the memory (e.g., the memory unit 10 may comprise a non-transitory computer-readable medium that stores instructions that when executed by processor performs any one, any combination, or all of the functions described herein). In this regard, the computing unit 9 may comprise any type of computing functionality, such as the at least one processor (which may comprise a microprocessor, controller, PLA, or the like) and the at least one memory. The memory may comprise any type of storage device (e.g., any type of memory). As shown in FIG. 9, computing unit 9 and memory unit 10 are depicted as separate elements. Alternatively, they computing unit 9 and memory unit 10 may be part of a single machine, which includes a microprocessor (or other type of controller) and a memory. Alternatively, computing unit 9 may rely on memory unit 10 for all of its memory needs.

The computing unit 9 and memory unit 10 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

A container 11 designed as a fuel tank may be integrated into the body of the agricultural production machine 1. The container 11 (alternatively termed tank) may be equipped with a level sensor 12, which may be configured to automatically transmit (wired and/or wirelessly) measurement data (e.g., sensor data indicative of the level in container 11) via a signal line to the driver assistance system 7 for the driver assistance system 7 to evaluate.

A sensor assembly 13 may be assigned to at least one of the axles 2, 3 (such as to each of the axles 2, 3) of the agricultural production machine 1. In one or some embodiments, the sensor assembly 13 is assigned to the front axle 2. Using the measurement data (interchangeably termed sensor data) provided or generated by the sensor assembly 13 and evaluated by the driver assistance system 7, the driver assistance system 7 may determine the axle load arising or impinging on the front axle 2.

Furthermore, the illustration in FIG. 1 schematically and exemplarily shows a device interface 14 of the agricultural production machine 1. The agricultural production machine 1 may have such a device interface 14 at the front and/or rear. In one or some embodiments, the device interface 14 may comprise a mechanical coupling between the agricultural production machine 1 and an attachment 15. For this purpose, the device interface 14 may be designed as a three-point power lifter.

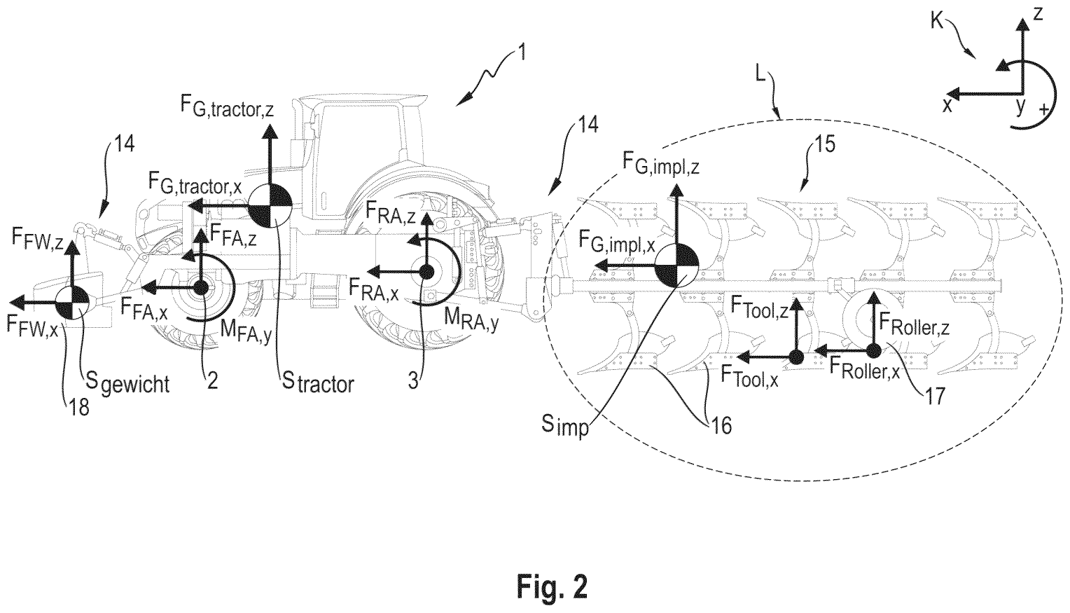

FIG. 2 schematically shows the agricultural work system comprising (or consisting of) agricultural production machine 1 and attachment 15 attached to device interface 14. The attachment 15 attached to the device interface 14 may be a soil cultivation device such as a plow, a cultivator, a harrow or the like in the illustrated example.

Absolute axle loads and axle load distribution may have a major influence on overall efficiency and operational safety when performing agricultural work processes. For example, an ideal axle load ratio may depend on the tires. The load transfer from the attachment 15 to the agricultural production machine 1 to reduce the tractive force requirement and rolling resistance may influence the axle load distribution and the absolute axle loads. Furthermore, the axle load distribution during the execution of a soil cultivation process may be influenced or affected by the soil resistance and/or the fill level of a container of the attachment 15. Another aspect may be that a minimum front axle load should not fall below a predetermined amount to enable sufficient steering behavior for the agricultural production machine 1. Furthermore, in one or some embodiments, the axle load ratio and/or the absolute axle loads should remain within designed limits to ensure the service life of the drive train.

Therefore, an axle load distribution setting that deviates significantly from an optimal setting may result in increased fuel consumption, reduced output per area, higher area-specific costs, and increased wear of the agricultural work system.

During the execution of agricultural work processes, operating parameters of the agricultural work system may change continuously, which may be due to external influences such as soil conditions, or internal influences such as changes in the weight of the attachment 15 due to fill level fluctuations. It may therefore be essential for an operator of the agricultural work system to be at least informed about the currently prevailing operation(s), such as vertical, axle loads and the resulting axle load ratio while performing agricultural work processes.

For this purpose, the computer unit 9 of the driver assistance system 7 of the agricultural production machine 1 may determine (such as cyclically or periodically determine) axle loads occurring, happening, or manifesting on axles 2, 3 of the agricultural production machine 1 and an axle load ratio based thereon. Thus, the driver assistance system 7 of the agricultural production machine 1, coupled in time to the execution of the work process, may consider or take into account the agricultural production machine and attachment configuration and operating parameters of the agricultural work system in determining the axle load(s) and/or the axle load ratio. The cyclic determination of the axle loads arising or impinging on the axles 2, 3 of the agricultural production machine 1 during the execution of the work process and the axle load ratio based thereon, which may be performed at specific, such as constant, time intervals, makes it possible for the driver assistance system 7 to automatically provide the operator with approximately real-time information about the dynamically changing axle loads and the axle load distribution during the execution of the work process.

The operating and display unit 8 may display any one, any combination, or all of the arising axle loads, the axle load ratio, and/or their changes during the execution of the work process, thereby providing a way in which to visualize these aspects to the operator. In this regard, the operator may be made aware early on of changes that may have a detrimental effect on the operation of the agricultural work system using graphically displayed curves of the various aspects, such as any one, any combination, or all of vertical, axle loads, and the axle load ratio.

An existing production machine and attachment configuration may be at least partially specified by the operator of the agricultural work system and/or at least partially determined automatically by the driver assistance system 7.

The agricultural production machine configuration may, among other things, comprise any one, any combination, or all of the mass of the agricultural production machine 1, the position of the center of gravity of the empty agricultural production machine 1, the mass and position of additional weights arranged on the agricultural production machine 1 such as, for example, front weight, wheel weight, front loader, container or the like, and the type of device interface on the agricultural production machine for connection to the attachment 15.

The attachment configuration may, among other things, comprise any one, any combination, or all of the mass of the attachment 15, the position of the center of gravity of the attachment 15, the point of application of the ground resistance forces and/or rolling resistances within the attachment 15, the position of at least one weight-supporting device optionally arranged on the attachment such as a support wheel arrangement 17.

In one or some embodiments, to determine the axle loads and the axle load ratio, a distinction may be made between attachments 15 mounted on the device interface 14 and trailed attachments 15. For this purpose, a device interface load L transmitted via the at least one device interface 14 may be determined in an attachment-specific manner. In this context, “attachment-specific” may mean that a distinction is made between the type of attachment 15, for example soil cultivation attachment or slurry tanker, and the connection to the device interface 14 by attachment or mounting and/or the use of a traction booster. The device interface load L may include weight-related load components, which may be gravity-related and/or inertia-related load components, as well as process-related load components, which may be due, for example, to the engagement between the attachment 15 and field soil that takes place during plowing or the like.

For the sake of simplicity, the device interface load L includes all relevant forces and moments from the attachment 15 that act on the agricultural production machine 1.

The agricultural work system shown in FIG. 2 shows the mounted attachment 15, which in the depicted embodiment is designed as a soil tillage attachment. The forces acting on the agricultural production machine and the attachment 15 are shown in FIG. 2 in relation to a coordinate system K of the agricultural work system. For example, the device interface load L comprises weight forces F_{G,impl,x} and F_{G,impl,z} acting in the x-direction and in the z-direction, respectively, which may act at the center of gravity Sᵢₘₚ of the attachment 15. Furthermore, the device interface load L may comprise forces F_{Tool,x}, F_{Tool,z}, F_{Roller,x}, F_{Roller,z} acting in the x-direction and in the z-direction, which may be caused by tools 16 and the at least one weight-supporting device designed as a support wheel arrangement 17. The x-direction designates the longitudinal direction of the vehicle, the y-direction the transverse direction of the vehicle, and the z-direction the vertical direction of the vehicle.

Forces and moments are shown in an analogous manner in the agricultural production machine 1. A weight 18 for ballasting may be arranged on the front device interface 14, as an example. Weight forces F_{FW,x} and F_{FW,z} acting in the x-direction and z-direction may be applied at the center of gravity S_{gewicht} of the weight 18. Horizontal and vertical axle loads F_{FA,x} and F_{FA,z} may act in the x-direction and in the z-direction (respectively) as well as a moment M_{FA,y} may act in the y-direction act on the front axle 2. Weight forces F_{G,tractor,x} and F_{G,tractor,z} acting in the x-direction and z-direction may be applied at the center of gravity S tractor of the agricultural production machine 1.

The driver assistance system 7 may determine any one, any combination, or all of the weight forces F_{G,tractor,x} and F_{G,tractor,z} of the agricultural production machine 1, the weight forces F_{G,impl,x} and F_{G,impl,z} of the attachment 15, and the weight forces F_{FW,x} and F_{FW,z} of the weight 18 for ballasting, with the driver assistance system 7 taking into account the terrain topology, and an inclination in the transverse and longitudinal vehicle directions.

Alternatively, or in addition, the driver assistance system 7 may determine any one, any combination, or all of the horizontal and vertical axle loads F_{RA,x} and F_{RA,z} acting in the x-direction and in the z-direction as well as a moment M_{RA,y} acting in the y-direction act on the rear axle 3.

The weight 18 at the front device interface 14 is to be understood merely as an illustrative example. Further weights 18 with corresponding weight forces taking into account the terrain topology and own centers of gravity are contemplated if, for example, additional wheel weights are provided, or the attachment 15 comprises an additional container for seed and/or fertilizer or a liquid. The sensor assembly may also determine fill levels of a container of the attachment 15. It is also contemplated to determine the weight force exerted by the container contents in order to detect changes in the weight on the attachment 15 in order to take these into account in the cyclical determination by the driver assistance system 7 of the vertical axle loads F_{FA,z} and F_{RA,z}.

In the case of the mounted attachment 15 designed for soil cultivation, in a first step, the driver assistance system 7 automatically determines the vertical force F_{Roller,z} supported on the support wheel arrangement from a moment equilibrium around the rear axle 3 of the agricultural production machine 1. In a second step, the driver assistance system 7 automatically determines the vertical axle load F_{RA,z} acting on the rear axle 3.

In a third step, the driver assistance system 7 automatically determines the axle load ratio from the vertical axle loads F_{FA,z}, F_{RA,z} currently acting on axles 2, 3 and, in a fourth step, the driver assistance system 7 may automatically estimate the drive torques M_{FA,y} and M_{RA,y} on the axles 2, 3 of the agricultural production machine 1.

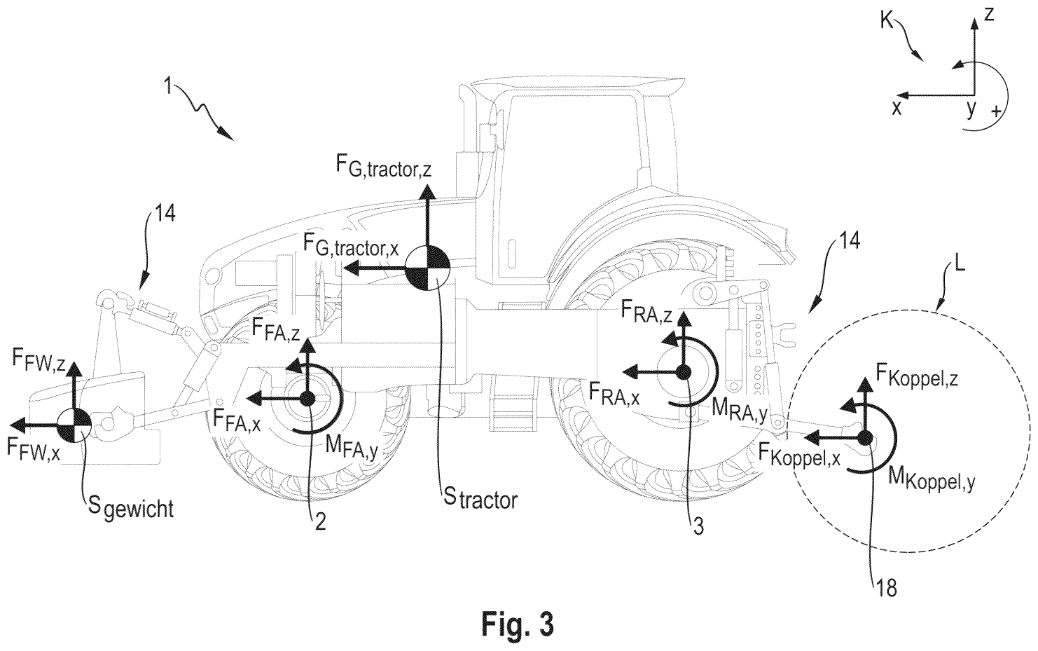

FIG. 3 schematically shows a representation of only the agricultural production machine 1 in an operating situation in which an attachment 15 is attached to the device interface 14. An example of the mounted attachment 15 is a seeder combination. The device interface load L may comprise coupling forces F_{Koppel,x} and F_{Koppel,z} acting in the x-direction and in the z-direction, respectively, and a coupling moment M_{Koppel,y} acting in the y-direction, which may act on the device interface 14 at a coupling point.

In the case of a trailed attachment 15 designed for soil cultivation, in a first step, the driver assistance system 7 automatically determines tool forces exerted on tools 16 of the attachment 15 via the tractive power and current travel speed of the attachment 15 (which may be determined based on a speed sensor on one or both of the agricultural production machine or the attachment), a coupling torque M_{Koppel,y} from the attachment 15 acting on the attachment 15, and a vertical coupling force F_{Koppel,y} by means of attachment geometry (e.g., the vertical coupling force is determined based on attachment geometry), which may be automatically determined by the driver assistance system from the attachment configuration, and a moment equilibrium formed around a support wheel arrangement 17. In a second step, the driver assistance system 7 automatically determines the vertical axle load F_{RA,z} acting on one of the axles 2, 3, in particular the rear axle 3.

When determining the coupling moment M_{Koppel,y} of a trailed attachment 15, the driver assistance system 7 automatically take into account the presence of a traction booster in the absence of an upper link connection.

On the other hand, with a trailed attachment 15 which may serve to transport harvested material, auxiliary materials and/or operating materials, the driver assistance system 7 may automatically estimate the rolling resistance in a first step to determine the coupling forces F_{Koppel,x} and F_{Koppel,z}. In the second step, the driver assistance system 7 automatically determines the vertical axle load F_{RA,z} acting on one of the axles 2, 3, in particular the rear axle 3.

As with the mounted attachment 15, in the third step, the driver assistance system 7 automatically determines the axle load ratio from the vertical axle loads F_{FA,z}, F_{RA,z} currently acting on axles 2, 3 and, in the fourth step, the driver assistance system 7 automatically estimates the drive torques M_{FA,y} and M_{RA,y} on the axles 2, 3 of the agricultural production machine 1.

To estimate the drive torque, the driver assistance system 7 may estimate a driving force coefficient using quantities determined in the first and/or second steps, such as any one, any combination, or all of the weight forces F_{FW,x}, F_{G,tractor,x}, F_{G,imp,x}, the force in the x direction F_{Roller,x} caused by the support wheel arrangement, and the vertical axle loads F_{FA,z}, F_{RA,z} on the front axle 2 and rear axle 3 for trailed or mounted attachments 15.

In addition to the container 11 designed as a fuel tank, the attachment 15 may also be designed with tanks, as previously explained above. During operation, the filling levels may change due to consumption of the auxiliary and/or operating materials contained therein. Therefore, the driver assistance system 7 may automatically take into account the variable filling volume of a container of the attachment 15 and/or of the agricultural production machine 1 and/or the spatial arrangement of the container 11 with respect to the agricultural production machine 1 when determining the dynamically changing vertical axle loads F_{FA,z}, F_{RA,z}. The driver assistance system 7 may automatically determine the position or spatial arrangement of a container on the agricultural production machine 1 and/or the attachment 15, among other things, by inputting the operator via the operating and display unit 8, from the agricultural production machine and attachment configuration saved in the memory unit 10. The change of the fill level may be detected by sensors.

To ensure high accuracy of the cyclic determination of the vertical axle loads F_{FA,z}, F_{RA,z} and the resulting axle load distribution, the driver assistance system 7 may automatically consider effects that may influence the measurement of the vertical axle load F_{FA,z} on the front axle 2. For example, the sensory determination of the vertical axle load F_{FA,z} on the front axle 2 by a direct pressure measurement in a hydropneumatic front axle suspension may not be able to take into account the mass of the unsprung part of the front axle 2 as well as the front soil engagement means, such as tires, tracks, or the like. When trailed attachments 15 are used, the coupling torque M_{Koppel,y} between the agricultural production machine 1 and the attached attachment 15 imposed by a traction amplifier may influence the axle load distribution.

To determine the dynamically changing vertical axle loads F_{FA,z}, F_{RA,z} in the work process according to one aspect of the invention, it may be necessary to know the initial ballasting of the agricultural production machine 1. Initial ballasting may include data on any one, any combination, or all of the empty weight of the agricultural production machine 1, the initial axle load distribution, or a coupling moment if a trailed attachment 15 with a torque transmitting traction amplifier is used. In addition, knowledge of the center of gravity Sᵢₘₚ of the attachment 15 may be relevant.

In one or some embodiments, the driver assistance system 7 may automatically specify a dialog-based procedure in order to automatically determine an initial ballasting of the agricultural production machine 1 and/or the attachment 15. In one or some embodiments, the operator may be guided using the operating and display unit 8 via a natural language dialog to perform the required steps and entries.

For a basic calibration of only the agricultural production machine 1, a sequence of steps may be provided which may include weighing on a scale. First, the proportional weight may be recorded of the agricultural production machine 1, which may be placed on the scale only with the front axle 2. Subsequently, a measuring routine may be executed through which an initial vertical axle load may be determined by the sensor assembly 13. Subsequently, the agricultural production machine 1 may be moved completely and entirely onto the scale and weighed. The fuel level in the container 11 may also be determined.

This may be followed by an attachment calibration, which may be performed after the mounting or attaching of the attachment 15 onto the agricultural production machine 1. First of all, the proportional weight may be recorded of the agricultural production machine 1 with the attachment 15 attached thereto, which may only be on the scale with the front axle 2. Subsequently, the measuring routine may be executed, by means of which the initial vertical axle load may be determined by the sensor assembly 13, taking into account the attachment 15. If, in the case of the attached attachment 15, a traction booster is provided, this is switched on and the proportional weighing and the subsequent measuring routine are executed again. The traction booster may then be switched off. Thereafter, the agricultural production machine 1 with the attached or mounted attachment 15 may be moved onto the scales, wherein only the axles 2, 3 of the agricultural production machine 1 are on the scales. The at least one optional support wheel arrangement 17 of the attachment 15 or wheels of an attachment 15 designed as a transport vehicle or slurry tank may not be on the scales. After the weight of the attachment 1 has been recorded, the complete agricultural work system may be moved onto the scale in order to determine the total weight. Subsequently, to determine the weight acting on at least one attachment axle, the attachment 15 with its at least one support wheel arrangement 17 or the vehicle axles may be driven onto the scale to record the weight of the attachment axle.

For both basic calibration and attachment calibration, the driver assistance system 7 may interactively guide the operator of the agricultural work system through all the process steps to be performed and, if necessary, may prompt the operator to enter data using the operating and display unit 8 (e.g., the operating and display unit 8 may comprise a touchscreen).

The driver assistance system 7 may compare the vertical axle loads F_{FA,z}, F_{RA,z} and the axle load distribution with limit values determined cyclically during the execution of the work process. If one of the limit values is passed, the driver assistance system 7 may automatically output at least one warning to the operator using the operating and display unit 8. The operator may therefore be made aware early on of an operating situation in which optimum operation of the agricultural work system is not possible with the existing operating parameters.

When one of the limit values is passed, the driver assistance system 7 may automatically determine an adjustment of at least one operating parameter, which may be automatically suggested to the operator using the operating and display unit 8 for manual selection and/or may be automatically implemented by the driver assistance system 7.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural production machine
2 Axle/front axle
3 Axle/rear axle
4 Soil engagement means
5 Soil engagement means
6 Drive unit
7 Driver assistance system
8 Operating and display unit
9 Computing unit
10 Memory unit
11 Container
12 Level sensor
13 Sensor assembly
14 Device interface
15 Attachment
16 Tool
17 Support wheel arrangement
18 Weight
F_{FA,x} Horizontal axle load of 2
F_{FA,z} Vertical axle load of 2
F_{RA,x} Horizontal axle load of 3
F_{RA,z} Vertical axle load of 3
M_{FA,y} Moment
M_{RA,y} Moment
F_{G,tractor,x} Weight force of 1
F_{G,tractor,z} Weight force of 1
F_{FW,x} Weight force of 18
F_{FW,z} Weight force of 18
F_{G,impl,x} Weight force of 15
F_{G,impl,z} Weight force of 15
F_{Tool,x} Force
F_{Tool,z} Force
F_{Roller,x} Force
Sᵢₘₚ Center of gravity of 15
S_{tractor} Center of gravity of 1
S_{gewicht} Center of gravity of 18
M_{Koppel,y} Coupling torque
F_{Koppel,x} Coupling force
F_{Koppel,z} Coupling force
K Coordinate system
x x direction
y y direction
z z direction

1. A method for operating an agricultural work system, the agricultural work system comprising an agricultural production machine having at least two axles with at least one device interface and an attachment connected to the agricultural production machine using the device interface, the agricultural work system for performing an agricultural work process, the method comprising:
accessing sensor data generating by a sensor assembly that is generated during performing of the agricultural work process;
automatically determining, using the sensor data and at least one computing unit, one or more axle loads on at least one axle of the agricultural production machine and an axle load ratio that account for a configuration of the agricultural production machine and the attachment and for one or more operating parameters of the agricultural work system; and
performing one or both of:
automatically generating an output on a display indicative of one or both of the one or more axle loads or the axle load ratio; or
automatically controlling at least a part of the agricultural work system based on the one or both of the one or more axle loads or the axle load ratio.

2. The method of claim 1, wherein the agricultural production machine includes a driver assistance system that comprises an operating and display unit; and
wherein the operating and display unit displays the one or more the axle loads, the axle load ratio, and changes to the one or both of the one or more axle loads or the axle load ratio.

3. The method of claim 1, further comprising determining the configuration of the agricultural production machine and the attachment by on one or both of:
specifying by an operator of the agricultural work system; or
automatically determining by a driver assistance system of the agricultural production machine.

4. The method of claim 1, wherein the agricultural production machine includes a driver assistance system; and
wherein the driver assistance system automatically determines the one or more axle loads and the axle load ratio by:
determining whether the attachment is attached to the agricultural production machine as a mounted attachment attached to the device interface or a trailed attachment; and
determining both of the one or more axle loads or the axle load ratio based on whether the attachment is attached to the agricultural production machine as the mounted attachment or as the trailed attachment.

5. The method of claim 4, wherein determining both of the one or more axle loads or the axle load ratio based on whether the attachment is attached to the agricultural production machine as the mounted attachment or as the trailed attachment comprises:
determining a device interface load transmitted to the agricultural production machine via the at least one device interface based on whether the attachment is attached to the agricultural production machine as the mounted attachment or as the trailed attachment.

6. The method of claim 5, wherein, responsive to determining that the attachment is for soil cultivation:
determining a plurality of tool forces that are exerted on tools of the attachment via tractive power and current travel speed of the agricultural production machine;
determining a vertical force supported on at least one weight-supporting device from a moment equilibrium about one of the axles of the agricultural production machine; and
determining a vertical axle load acting on the one of the axles of the agricultural production machine.

7. The method of claim 6, wherein, in a first step, the plurality of tool forces and the vertical force are determined;
wherein in a second stop the vertical axle load is determined;
wherein the vertical force is determined from the moment equilibrium about a rear axle of the agricultural production machine; and
wherein the vertical axle load is determined for the rear axle of the agricultural production machine.

8. The method of claim 5, wherein, responsive to determining that the attachment is attached as a trailed attachment for soil cultivation:
determining forces exerted on tools of the attachment via tractive power and a current travel speed of the agricultural production machine;
determining a coupling torque based on attachment geometry;
determining a moment equilibrium around at least one weight-supporting device of the attachment; and
determining a vertical axle load acting on one of the axles.

9. The method of claim 8, wherein in a first step, the forces, the coupling torque, and the moment equilibrium are determined;
wherein, in a second step, the vertical axle load is determined; and
wherein the vertical axle load is determined for a rear axle of the agricultural production machine.

10. The method of claim 5, wherein, responsive to determining that the attachment is attached as a trailed attachment for transporting harvested material, auxiliary materials and/or operating materials:
estimating rolling resistance to determine a plurality of coupling forces; and
determining a vertical axle load acting on one of the axles.

11. The method of claim 4, wherein, in a first step, forces exerted on tools of the attachment are determined;
wherein, in a second step, a vertical axle load acting on one of the axles is determined;
wherein, in a third step, the axle load ratio is determined; and
wherein, in a fourth step, an estimation of a driving torque on the axles of the agricultural production machine is performed.

12. The method of claim 11, wherein, for the estimation of the driving torque, an estimation of a driving force coefficient is performed using quantities determined in the first step and the second step for attached or mounted attachments.

13. The method of claim 1, wherein automatically determining one or more axle loads comprises determining a vertical axle load; and
wherein the vertical axle load is determined dependent on one or both of:
a variable filling volume of a container resident on one or both of the agricultural production machine or of the attachment; or
a spatial arrangement of the container with respect to the agricultural production machine.

14. The method of claim 1, wherein the agricultural production machine includes a driver assistance system; and
further comprising determining an initial ballasting of one or both of the agricultural production machine or the attachment using a dialog-based sequence specified by the driver assistance system.

15. The method of claim 1, further comprising:
automatically comparing the axle loads and an axle load distribution with limit values; and
responsive to determining the axle loads or the axle load distribution exceeds respective limit values, automatically generating the output on the display indicating a warning.

16. The method of claim 15, wherein responsive to determining the axle loads or the axle load distribution exceeds respective limit values:
automatically determining an adjusted operating parameter for modifying operation of at least one of the agricultural production machine or the attachment;
performing one or both of:
automatically generating the output on the display with the adjusted operating parameter; or
automatically executing the adjusted operating parameter in order to modify operation of at least one of the agricultural production machine or the attachment.

17. An agricultural work system comprising:
an agricultural production machine including: at least two axles; at least one device interface; a sensor assembly positioned on at least one of the at least two axles and configured to generate data in order to determine an axle load and; and a driver assistance system; and
an attachment configured to connect to the agricultural production machine using the at least one device interface, the attachment configured to perform an agricultural work process;
wherein the driver assistance system is configured to:
access sensor data generating by the sensor assembly that is generated during performing of the agricultural work process;
automatically determine, using the sensor data and at least one computing unit, one or more axle loads on at least one axle of the agricultural production machine and an axle load ratio that account for a configuration of the agricultural production machine and the attachment and for one or more operating parameters of the agricultural work system; and
perform one or both of:
automatically generating an output on a display of the agricultural production machine indicative of one or both of the one or more axle loads or the axle load ratio; or
automatically controlling at least a part of the agricultural work system based on the one or both of the one or more axle loads or the axle load ratio.

18. The agricultural work system of claim 17, wherein the agricultural production machine includes an operating and display unit; and
wherein the operating and display unit is configured to display the one or more the axle loads, the axle load ratio, and changes to the one or both of the one or more axle loads or the axle load ratio.

19. The agricultural work system of claim 17, wherein the driver assistance system is configured to automatically determine the one or more axle loads and the axle load ratio by:
determining whether the attachment is attached to the agricultural production machine as a mounted attachment attached to the device interface or a trailed attachment; and
determining both of the one or more axle loads or the axle load ratio based on whether the attachment is attached to the agricultural production machine as the mounted attachment or as the trailed attachment.

20. The agricultural work system of claim 19, wherein the driver assistance system is configured to automatically determine both of the one or more axle loads or the axle load ratio based on whether the attachment is attached to the agricultural production machine as the mounted attachment or as the trailed attachment by:
determining a device interface load transmitted to the agricultural production machine via the at least one device interface based on whether the attachment is attached to the agricultural production machine as the mounted attachment or as the trailed attachment.
